(19) United States
(12) Patent Application Publication
(10) Pub. No.: US 2013/0017853 A1
(43) Pub. Date: Jan. 17, 2013

(54) Wholesale Network User Identity Mapping in a Mobile Network

(71) Applicants: Kjell Johansson, (US); Saikumar Devulapalli, Plano, TX (US); Kaniz Mahdi, Carrollton, TX (US); Mahdi Ali Hirab, Pierrefonds (CA); Ruth Guerra, Stockholm (SE); Ranjeet Verma, Allen, TX (US)

(72) Inventors: Kjell Johansson, (US); Saikumar Devulapalli, Plano, TX (US); Kaniz Mahdi, Carrollton, TX (US); Mahdi Ali Hirab, Pierrefonds (CA); Ruth Guerra, Stockholm (SE); Ranjeet Verma, Allen, TX (US)

(73) Assignee: TELEFONAKTIEBOLAGET L M ERICSSON (PUBL), Stockholm (SE)

(21) Appl. No.: 13/295,685

(22) Filed: Nov. 14, 2011

Related U.S. Application Data
(60) Provisional application No. 61/506,751, filed on Jul. 12, 2011.

(51) Int. Cl. H04W 8/20

(52) U.S. Cl. 455/517

(57) ABSTRACT

A method, in a network node, for mapping a wholesale network user's identity onto a mobile network user identity that is routable in the mobile network, comprises: receiving, through a communication interface of the network node, a request from the user of the wholesale network for a service provided by the mobile network, where the user of the wholesale network is not registered in the mobile network. The method further comprises, based on the requested service, selecting a routable identity among a group of identities associated with the requested service, in the mobile network, by a processor of the network node. Finally, the method comprises: mapping the selected routable identity of the mobile network to the wholesale network user's identity, by the processor of the network node.

### PRIORITY STATEMENT UNDER 35 U.S.C. S.119(e) & 37 C.F.R. S.1.78

This non-provisional patent application claims priority based upon the prior U.S. provisional patent application entitled “Wholesale identities mapping and management in an IMs network”, application No. 61/506,751, filed on Jul. 12, 2011, in the names of Kjell Johansson M., Saikumar Devulapalli, Kaniz Mandi, Mandi-Ali Hirab, Ruth Guerra and Ranjeet Verma.

### TECHNICAL FIELD

The present invention generally relates to communication networks. More specifically, the present invention is concerned with a method and system for mapping wholesale network's user identities in a mobile network.

### BACKGROUND

Over the past few decades, Internet has experienced an incredible growth and expansion. Technologies have changed from centralized computing to personalized computing, to mobile computing and now to intelligent services with a convergence of networks, devices and services along with different business models.

Furthermore, wholesale networks have emerged recently, where telcos (telecommunications companies) share their physical network and equipments with a plurality of different independent Service Providers (SPs). The wholesale networks allow, for example, for delivering new services and technologies quicker; and from the customer perspective, the wholesale idea can mean lower prices for the services offered to the customers.

In a wholesale network business model where communication services, such as voice, video, messaging, etc., are provided by a network operator, there is a challenge for the network operator to manage and map the wholesale network's users identity in the overall architecture of the operator's network for scalability, distribution, etc.

Indeed, the identities of the subscribers/users of the wholesale network are owned and managed by the wholesale network. The wholesale network identities are not routable or usable outside of the wholesale network so that such identities cannot be used in the operator's network for communications.

For example, let's say that the wholesale network is Facebook™ or Google and the operator is AT&T, and that the business model between Facebook™ and AT&T is to provide the users of Facebook™ communications services such as voice, call forwarding, and video by AT&T.

In current systems, the users in the wholesale network (Facebook™) cannot use his/her identity (e.g. Facebook™ username) to make a voice/video call through the PSTN to another wholesale network user while he/she is using the wholesale client. Indeed, currently, there is no solution that allows a wholesale network user to use his/her wholesale network user identity in any other networks, to which he/she is not registered.

One solution to this problem would be to use a one to one mapping from the wholesale network user identity to a permanent identity in the mobile network, for example. However, this one to one mapping is not scalable for the network operator and requires too much provisioning. Therefore other solutions are needed.

### SUMMARY

More specifically, in accordance with the present invention, there is provided a method for mapping a user's identity from a wholesale network to a mobile network in a network node. The method comprises: receiving, through a communication interface of the network node, a request from the user of the wholesale network for a service provided by the mobile network, where the user of the wholesale network is not registered in the mobile network; based on the requested service, selecting, by a processor of the network node, a routable identity among a group of identities associated with the requested service, in the mobile network; and mapping the selected routable identity of the mobile network to the wholesale network user's identity, by the processor of the network node.

According to another aspect of the present invention, there is provided a network node for mapping a wholesale network user's identity into a mobile network user identity. The network node comprises: a communication interface for receiving a request from the user of the wholesale network for a service provided by the mobile network, where the user of the wholesale network user is not registered in the mobile network; a processor operationally connected to the communication interface; and an instruction repository operationally connected to the processor and storing instructions that when executed by the processor cause the processor to: based on the requested service, select a routable identity among a group of identities associated with the requested service, in the mobile network; and map the selected routable identity of the mobile network to the wholesale network user's identity.

According to a further aspect of the present invention, there is provided a method for using a wholesale network user's identity to access services provided by a mobile network. The method comprises, in a network node: receiving, through a communication interface of the network node, a request for a service from the wholesale network user who is not a subscriber of the mobile network; looking up in a database a routable identity in the mobile network mapped to the wholesale network user's identity, by a processor of the network node; replacing an identifier of the received request of service with the located routable identity, by the processor of the network node; and sending, through the communication interface, the request using the routable identity through the mobile network for accessing the requested service in the mobile network, where the routable identity is mapped to the wholesale network user based on the requested service.

According to yet another aspect of the present invention, there is provided a network node for using a wholesale network user's identity to access services provided by a mobile network. The network node comprises: a communication interface for receiving a request for a service from the wholesale network user who is not a subscriber of the mobile network; a processor operationally connected to the communication interface; and an instruction repository operationally connected to the processor and storing instructions that when executed by the processor cause the processor to: locate a routable identity mapped to the wholesale network user's identity in a database of the mobile network; and replace an identifier of the received request of service with the located routable identity. The communication interface further sends the request using the routable identity through the mobile network for accessing the requested service in the mobile network; and the routable identity is mapped to the wholesale network user identity based on the requested service.

The foregoing and other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a schematic view of an architecture of a wholesale network in communication with a mobile network according to an embodiment of the present invention;

FIG. 2 illustrates the architecture of FIG. 1 wherein the mobile network is an IMS network;

FIG. 3 is a flow chart illustrating a method of mapping a wholesale network user's identity to a mobile network user identity according to an embodiment of the present invention;

FIG. 4 is a schematic view of a network node for carrying the method of FIG. 3 according to an embodiment of the present invention;

FIG. 5 is a sequence flow for associating a wholesale network user's identity to a routable identity in the mobile network according to an embodiment of the invention;

FIG. 6 is a mapping scheme between a wholesale network user's identity and a routable identity in the mobile network according to an embodiment of the present invention;

FIG. 7 is a method for using a wholesale network user's identity to access services from a mobile network according to an embodiment of the present invention; and

FIG. 8 is a schematic view of a network node for carrying the method of FIG. 7 according to an embodiment of the present invention.

### DETAILED DESCRIPTION

Before going further into the description of embodiments of the present invention, an acronym list is provided:

| | |
|---|---|
| DNS | Domain Name System |
| eDNS | External DNS |
| H2S | HTTP to SIP gateway |
| HSS | Home Subscriber Server |
| I-CSCF | Interrogating Call Session Control Function |
| IMPU | IP Multimedia Public ID |
| IMPI | IP Multimedia Private ID |
| IMS | Internet protocol Multimedia Subsystem |
| IRS | Implicit Registration Set |
| MTAS | Multimedia Telephony Application Server |
| PSTN | Placement Opportunity Information Service |
| SBG | Session Border Gateway |
| S-CSCF | Serving Call Session Control Function |
| SIP | Session Initiation Protocol |
| SIP URI | SIP Uniform Resource Identifier |
| W-CSCF | Wholesale CSCF |
| WEC | Wholesale Enabled Client |
| W-IMPU | Wild-carded IMPU |
| WT | Web Terminating |
| WUD | Wholesale User Database |

Generally speaking, embodiments of the present invention introduce a mapping scheme of wholesale network user identities onto another network's user identities, such as an operator's mobile network, where the wholesale network user is not registered in the mobile network. More specifically, upon receipt of a requested service from the user of the wholesale network, a routable identity in the mobile network is selected from a group of identities associated with the requested service. Then, the selected routable identity of the mobile network is mapped to the wholesale network user's identity. By so doing, the wholesale network user's identity can be used by a user who does not belong to the wholesale network to reach the wholesale network user. Also, through this mapping, the wholesale network user can access services provided by the operator's network even though she/he is not registered in the operator's network. In other words, the user in the wholesale network can be reached from the operator's network and select communication services, such as voice and video that are suitable for him/her and provided by the operator's network. For example, the user in the wholesale network would be able to make calls and/or receive calls. For example, by mapping his Facebook™ identity (john.doefacebook.com) unto a routable identity in the mobile network, a user of the mobile network can reach John Doe using his Facebook™ identity or John Doe can call the user of the mobile network using his Facebook™ identity.

The embodiments of the present invention also allow for managing such identity mappings in the operator's network. Embodiments of the present invention are described in the context of the IMS network as being the operator's mobile network. However, it is understood that the embodiments of the present invention are not restricted to such a network.

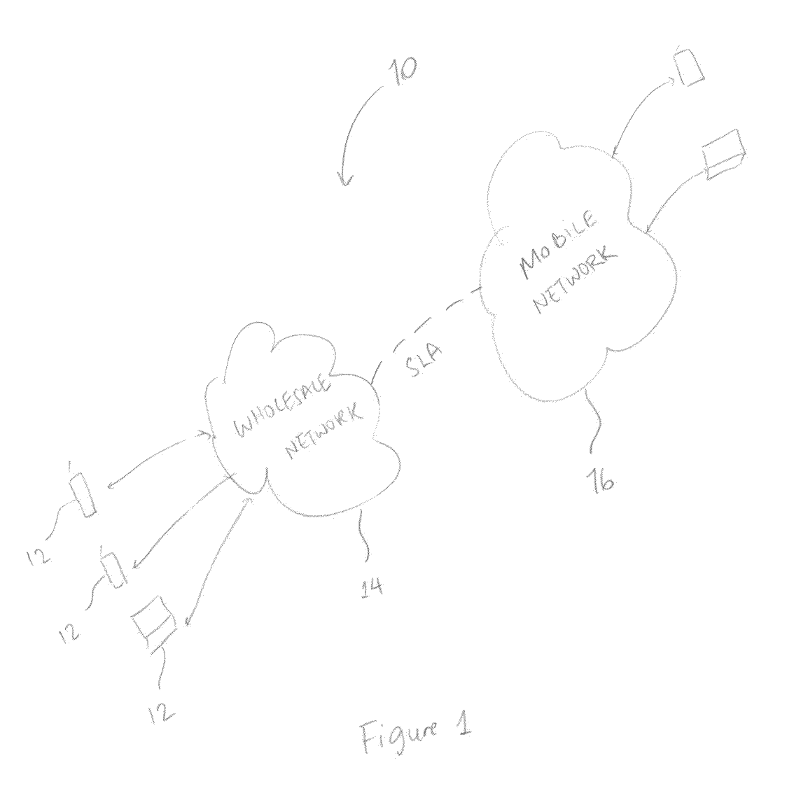

Now turning to FIG. 1, an architecture of a wholesale network in communication with a mobile network will be described.

The architecture 10 of FIG. 1 comprises users 12 which are identified by the devices they are using, such as a mobile phone, a computer, a PDA, a tablet, etc. The users 12 can connect to a wholesale network 14. For example, the wholesale network 14 can be Facebook™ All the users 12 who are registered in Facebook™ are part of the Facebook™ community. However, if the users 12 are not registered in a mobile network, such as the mobile network 16, they do not belong to the mobile network 16 and thus cannot use the services provided by the mobile network 16, such as voice and video calls, call forwarding, voice messaging, etc.

However, if the wholesale network 14 has a service level agreement (SLA) with the mobile network 16 (or a business model), then the mobile network 16 could allow the users 12 of the wholesale network 14 to use the services provided by the mobile network 16. But it poses a problem because the users 12 who use their wholesale network identity to register to the wholesale network 14 are not known to the mobile network 16, i.e. the wholesale network identities are only usable in the wholesale network 14 itself and not in any other networks.

Accordingly, an embodiment of the present invention is to provide an identity mapping between the user identities in the wholesale network 14 and identities in the mobile network 16, which is scalable for the mobile network 16.

When a service level agreement exists between the wholesale network 14 and the mobile network 16, the infrastructure 10 illustrates a business to business to consumer (B2B2C) model.

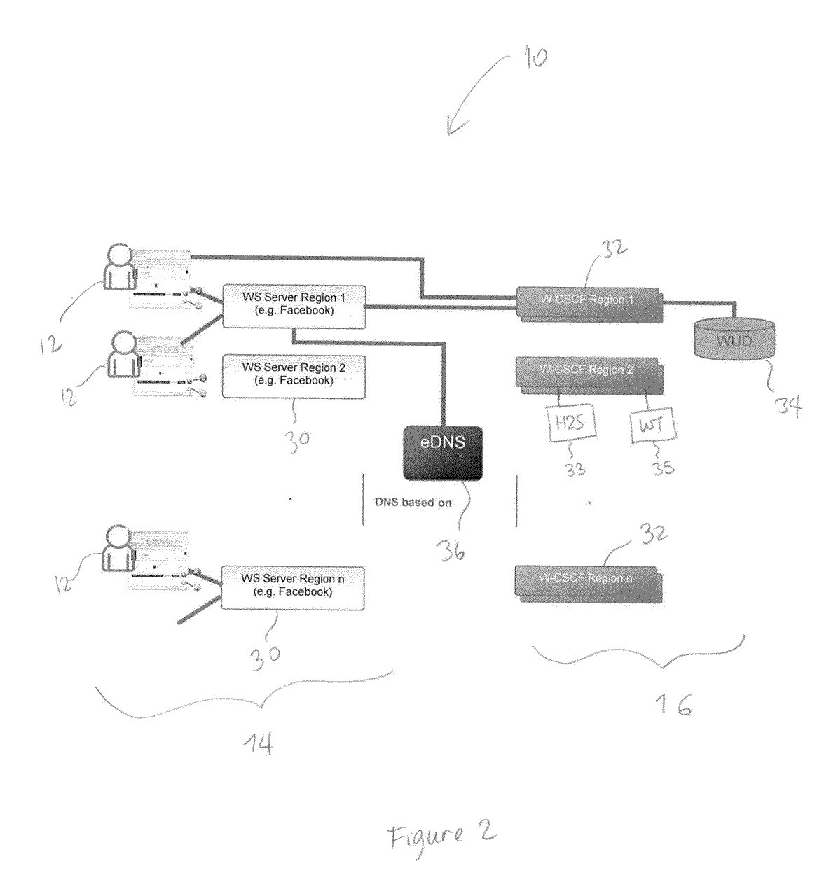

More specifically, turning to FIG. 2, a detailed view of the architecture 10 is provided. For example, the wholesale network 14 comprises n regions of wholesale servers 30, such as Facebook™ servers. The wholesale servers 30 are connected to the mobile network 16, through respective W-CSCFs 32, in this case the mobile network 16 is an IMS network. However, it should be understood by people skilled in the art that other kinds of networks could be used. Each of the W-CSCFs 32 may comprise a Wholesale User Database (WUD) 34, for containing information regarding the wholesale network users. The wholesale servers 30 may also be connected to an external DNS 36, which is used by wholesale networks and applications which are not part of the operator's network or applications which are part of the operator's network but which are available to other networks.

Furthermore, each of the W-CSCF 32 may comprise a network node, such as a HTTP to SIP gateway (H2S) 33 and a Web Terminal component (WT) 35, which will be described later on.

More specifically, according to an embodiment of the present invention, the network node W-CSCF 32 and more particularly the H2S 33, allows for mapping wholesale network user identities into routable identities in the IMS network 16 (or a mobile network), as will be described hereinbelow.

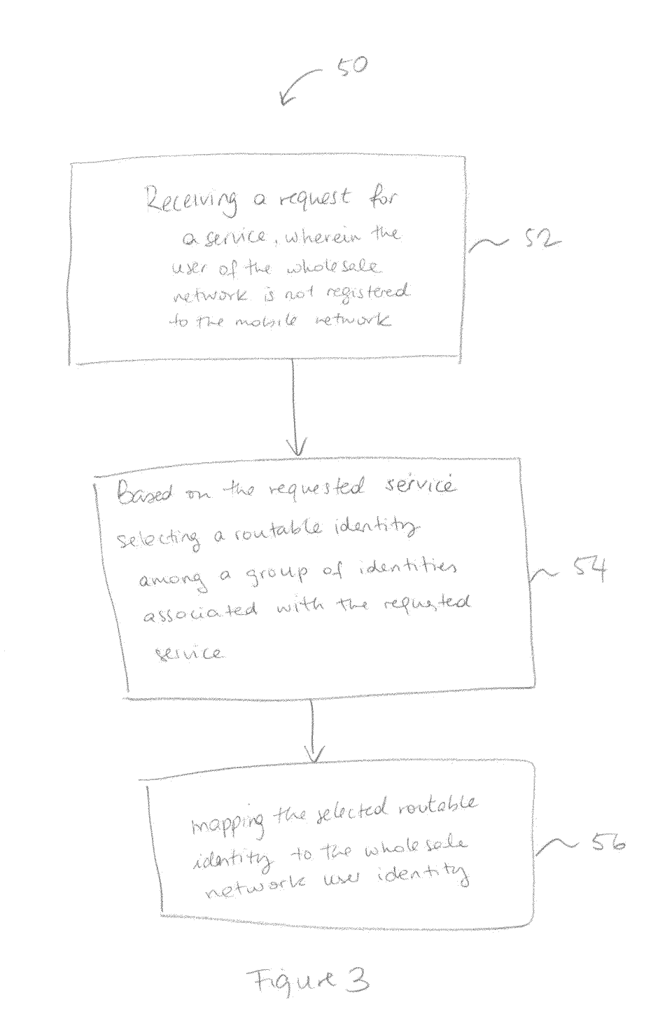

Now turning to FIG. 3, a method 50 for mapping a wholesale network user's identity onto a mobile network user identity, that is routable in the mobile network, will be described. The method 50 may be carried out in a network node, such as the H2S 33 located within the W-CSCF 32.

The method 50 comprises receiving a request from the user 12 of the wholesale network 14 for a service provided by the mobile network 16, wherein the user 12 of the wholesale network 14 is not registered in the mobile network (step 52), meaning that the wholesale network user is not a subscriber of the mobile network 16. The services can be voice or video calls, for example.

Based on the requested service, the method 50 selects a routable identity within the mobile network 16 among a group of identities associated with the requested service (step 54).

The method 50 further comprises mapping the selected routable identity to the wholesale network user identity (step 56). By so doing, the wholesale network user 12 can access the requested service in the mobile network 16 and can be reached by other users of the mobile network 16.

It should be noted that when a mapping between the wholesale network user identity and the selected routable identity is performed, an association is made between those two identities, as will be described hereinbelow.

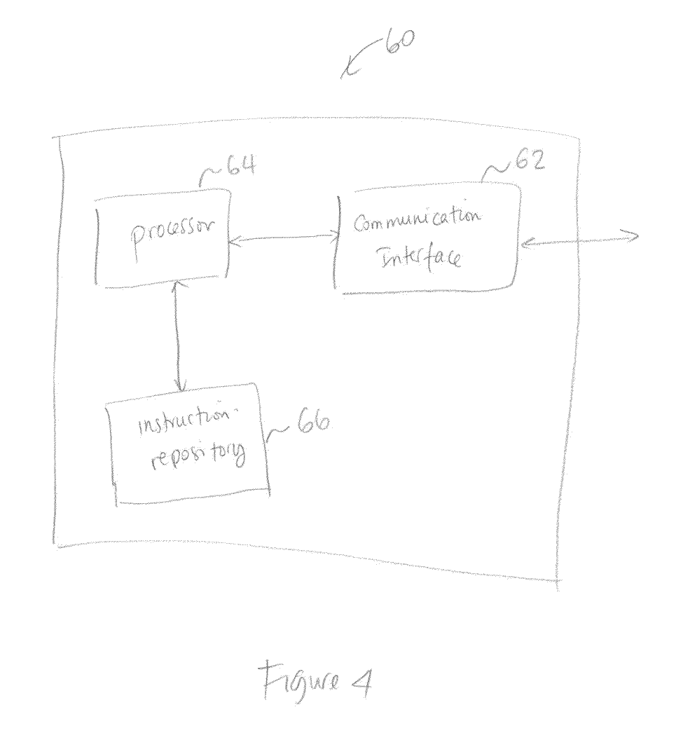

FIG. 4 illustrates a network node 60, such as the H2S 33 to carry out the method 50 as described above.

The network node 60 comprises a communication interface 62, a processor 64 operationally connected to the communication interface 62 and an instruction repository 66 operationally connected to the processor 64.

The communication interface 62 is used to receive a request from the user 12 of the wholesale network 14 for a service provided by the mobile network 16, wherein the user 12 of the wholesale network 14 is not registered in the mobile network.

The instruction repository 64 stores instructions that when executed by the processor 64 cause the processor to perform the steps 54 and 56 of method 50, as describe above.

Of course, the network node 60 may also comprise a plurality of other components (not shown), such as other processors and/or memory, for performing its usual tasks and procedures, which are well known in the art and thus will not be described further.

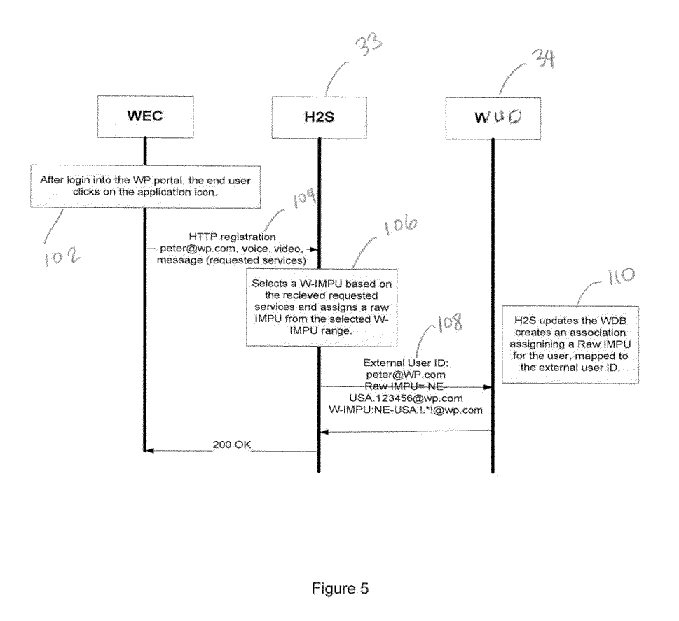

Now, turning to FIG. 5, a sequence flow 100 illustrating the mapping method of FIG. 3 will be described in the context of the wholesale network 14 having a service level agreement with the IMS network 16.

It should be noted that IMS networks are well-known in the art and thus they will not be described in detail.

The wholesale network user 12 Iogins into a web portal through its wholesale enabled client, installed on his computer or mobile phone, for example, in order to request a service or a plurality of services from the IMS network 16 (step 102). The wholesale network user 12 uses an identity such as peter@wp.com to do so.

The request is sent to the network node H2S 33 (step 104) within the W-CSCF 32.

At step 106, the network node H2S 33 selects a group of identities in the IMS network 16, associated with the requested services. For example, the group of identities is represented by a W-IMPU. In this case, the network node H2S 33 selects a W-IMPU based on the requested services that have been received. Then, within the range/group of identities given by the selected W-IMPU, the network node H2S 33 further selects a specific IMPU, that is available, for example, to be mapped to the wholesale network user 12. The specific IMPU is a routable identity, within the IMS network 16.

In step 108, the wholesale network user identity and the selected routable identity are sent to the WUB 34.

In the WUD 34, an association is made between the wholesale network user identity and the routable identity (step 110), i.e. the routable identity is mapped onto the wholesale network user identity. The routable identity is valid within the IMS network 16, as long as the association is valid. When the wholesale network user 12 leaves his/her session of the wholesale network 14, then the association is broken and the routable or internal identity is no longer assigned/mapped to the wholesale network user 12. However, as long as the association is valid (the wholesale network user 12 is connected to his/her session of the wholesale network 14) a user, not being part of the wholesale network 14, can reach the wholesale network user 12 using his/her wholesale network user identity and the wholesale network user 12 can reach the user belonging to the IMS network 16, even though the wholesale network user 12 does not belong to the IMS network 16, i.e. he/she is not registered in the IMS network 16. The routable identity is dynamically assigned/mapped to a wholesale network user identity.

Furthermore, in order to address capacity limitations, for example, a given W-IMPU is only served by a single logical S-CSCF, the wholesale network subscribers/users are partitioned into several W-IMPUs, i.e. a logical partitioning is performed to the W-IMPU in order to obtain many W-IMPUs according to different regions as shown in FIG. 2.

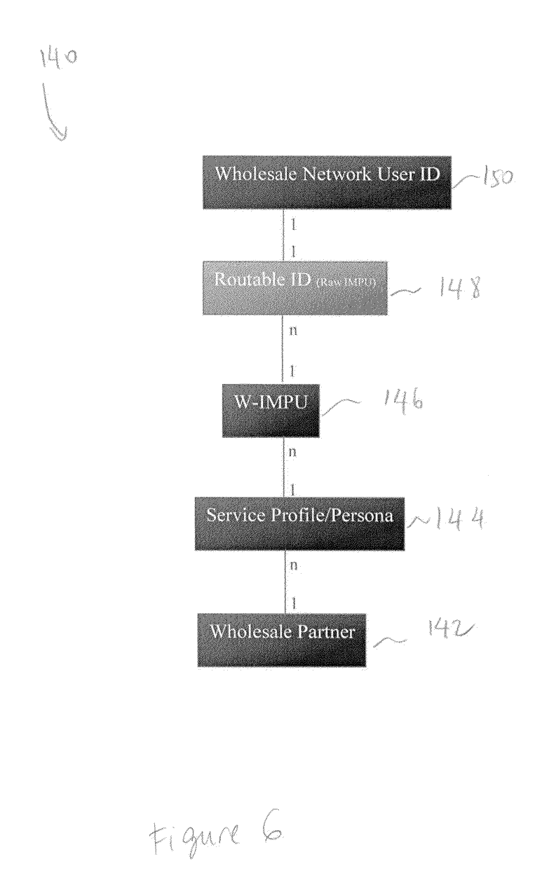

Now turning to FIG. 6, the mapping scheme between the wholesale network user identity and the routable identity of the IMS network 16 will be described in more detail.

The mapping scheme 140 can be illustrated through an assignment chain, which is represented by the different boxes of FIG. 6.

The wholesale network 14, which has a service level agreement with the mobile network 16, is now called a wholesale partner 142. The wholesale partner 142 can be Facebook™, for example.

The wholesale partner 142 is assigned to a plurality or a number n of service profiles or personas 144 for its subscribers. More specifically, a service profile/persona 144 comprises a combination of services. The wholesale partner 142 may define the plurality of service profiles/personas for its subscribers/users. The wholesale network user selection of services is mapped to a specific service profile/persona. Each user may select one set of services at a given time (short term). However, in the long term, users may have more than one service profile simultaneously. Furthermore, service profiles/personas can be shared by a group of wholesale network users 12. The service profiles/personas for a given wholesale partner 142 can be predefined by the network operator in consultation with the wholesale partner 142. A persona/service profile is denoted by alpha-numeric string, for example, “HomeOffice”, “Commercial”, “Residential”, etc.

All the service profiles 144 are stored in the HSS database of the IMS network 16.

Each service profile/persona 144 is associated with a plurality (or a number n) of W-IMPU. The format of the W-IMPU can be given by an extended regular expression for the user part of the SIP URI, followed by the domain name, for example NE-HomeOffice-*@wp.com. The regular expression based on the W-IMPU allows a group of wholesale network users 12 to access a specific persona/service profile 144 in a specific geographic region, without adding the wholesale network users' record in the HSS of the IMS network. By so doing, it allows the operator's network to scale the number of sessions independently of the number of wholesale network users 12. Indeed, only the W-IMPU is provisioned (recorded) in the HSS of the IMS network. The associations between the wholesale network users and the routable identities are not recorded in the HSS.

The plurality of W-IMPUs 146, associated with a particular service profile/persona 144, for a given wholesale partner 142, can be pre-defined by the network operator in consultation with the wholesale partner 142. They can be defined by using a combination of the following criteria, for example:
personas supported by the wholesale partner 142;
geographic partitioning of the wholesale partner user space; and
types of services invoked by each group of users.

Each W-IMPU 146 is associated with a plurality (or a number n) of routable identities (IDs), which are specific IMPUs 148. The routable ID 148 is only used within the operator's network, an IMS network for example, and is not visible to wholesale network users. The “specific IMPU” format is supported, for example, NE-HomeOffice-10002@wp.com. The “specific IMPUs” 148 are dynamically created by the H2S 33 and are maintained in the IMS network as long as an association with a wholesale network user 12 is valid. The “specific IMPUs” or the routable ID 148 is used to handle, for example, service triggering and call routing for wholesale network users 12 within the IMS network without registration of those users in the IMS network. A specific IMPU 148 is dynamically assigned to a user of the wholesale partner 142 and stored in the WUD 33 upon the creation of the association, as described in FIG. 5.

Finally, the routable ID 148 is assigned/mapped to the wholesale network user identity (ID) 150. The mapping is a one to one mapping in this case.

The wholesale network user ID 150 is visible to the wholesale network users. The wholesale network user ID 150 is used to call out or reach them; it can be for example, the Facebook™ ID if the wholesale network is Facebook™. The wholesale network user ID 150 is statically assigned to the users. The supported formats for the wholesale network user ID 150 can be, for example:
SIP URI (ex. SIP:John.Doe@facebook.com)
TEL URI (ex. TEL:9724654588@facebook.com).

The exemplary embodiment illustrated in FIG. 6 allows to assign and map a routable ID within the IMS network to an external user ID of a wholesale partner user, through the illustrated assignment chain, so that this user can use the communication services offered by the IMS network. The assignment of the routable ID is temporary, meaning that once the user logs out of the wholesale network, the association between the wholesale network user ID 150 and the routable ID 148 is terminated. Furthermore, the routable ID 148 is selected from a group of W-IMPU 146, based on the services requested by the users 12 of the wholesale network 14.

More specifically, the relationship between users, the specific IMPU and personas/service profiles for the wholesale network users 12 can be represented as follows:

Specific IMPU 148=Function (External User ID 150, H2S ID, Persona ID 144)=Function (John.Doe@wp.com, H2S_{—}1, “HomeOffice”)=NE-HomeOffice-10002@wp.com; where H2S ID is the identity of the H2S 33.

Each specific IMPU 148 belongs to a W-IMPU group 146. For example: NE-HomeOffice-10002@wp.com belongs to the W-IMPU NE-HomeOffice*@wp.com. Each W-IMPU 146 is associated with a specific service profile 144: for example, NE-HomeOffice-*@wp.com is associated with the service profile “HomeOffice-wp”.

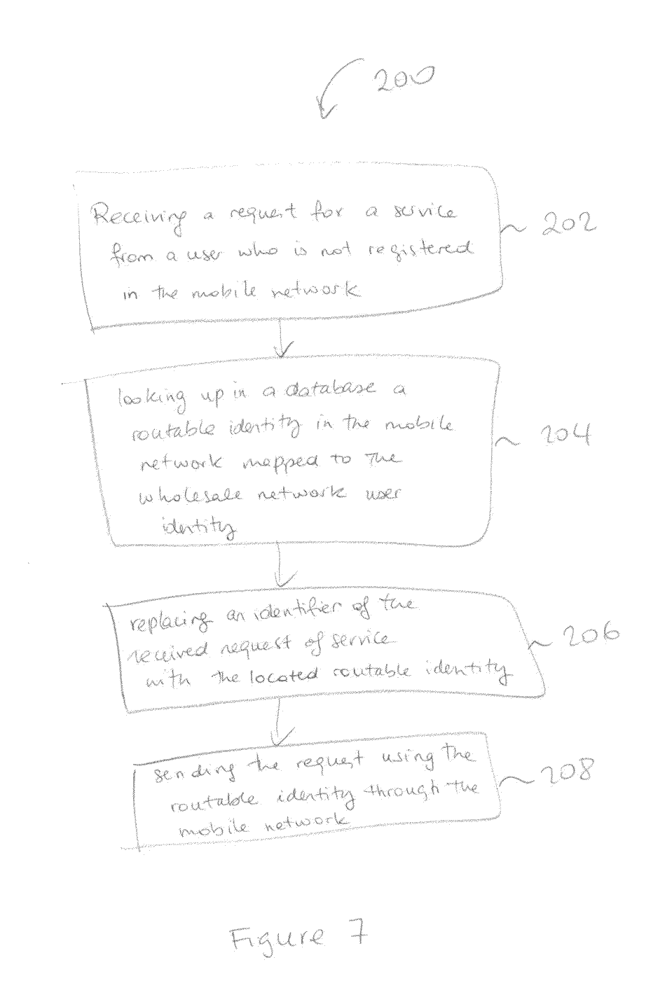

Now turning to FIG. 7, a method 200 for using a wholesale network user's identity to access services from a mobile network is described, where the wholesale network user is not a subscriber of the mobile network 16. The method is carried out in a network node, such as a web terminating component 35, that can be added in the W-CSCF 32 of FIG. 2 in the IMS network 16.

The method 200 starts with step 202 where the web terminating component 35 receives a request for a service from a user 12 of the wholesale network 14. The user 12 may use his wholesale network identity such as peter@wp.com as the request URI.

In step 204, the web terminating component 35 performs a lookup in the WUD 33 using the wholesale network user identity in order to locate a routable identity mapped to the wholesale network user and a service profile that is associated with the requested service.

Once the web terminating component 35 finds the routable identity mapped to the wholesale network user identity, it replaces the Request URI with the routable identity in step 206.

The request is sent to the IMS network 16 using the routable identity in step 208, so that the IMS network 16 can route and perform the service requested by the wholesale network user 12 using the routable identity in the IMS network 16.

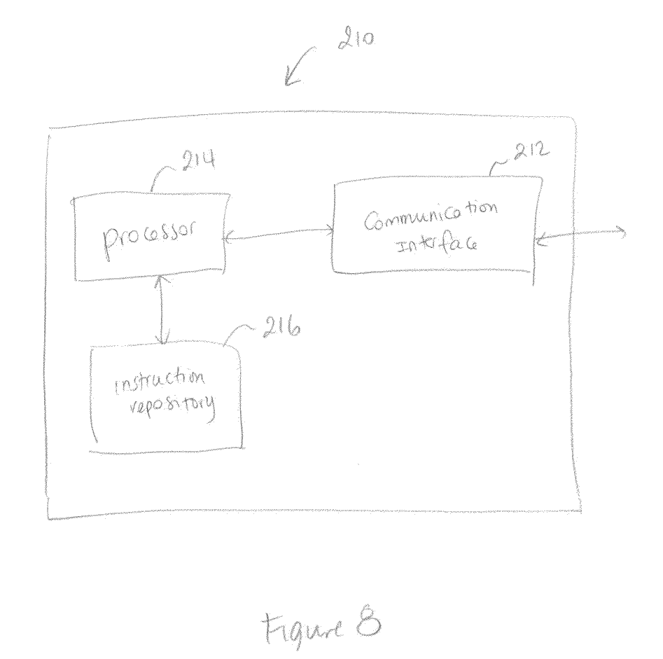

FIG. 8 illustrates a network node, such as the web terminating component 35 to carry out the method 200.

The network node 210 comprises a communication interface 212, a processor 214 operationally connected to the communication interface 212, and an instruction repository 216 operationally connected to the processor 214.

The communication interface 212 receives the request for a service by wholesale network user 12, where the request URI is given by the wholesale network user identity.

The instruction repository 216 stores instructions that when executed cause the processor 214 to perform a lookup in the WUD 33 to locate the routable identity that has been mapped to the wholesale network user identity, after receiving the request for a service. The processor 214 can also locate a service profile that is associated with the requested service.

Once the processor 214 has located the routable identity, it further replaces the wholesale network user identity with the located routable identity in the request URI. Then the new request with the routable identity is sent through the IMS network via the communication interface 212 of the network node. By using the routable identity, the IMS network can route properly the request and perform the requested service.

Of course, the network node 210 may also comprise a plurality of other components (not shown), such as other processors and/or memory, for performing its usual tasks and procedures, which are well known in the art and thus will not be described further.

Advantages of the embodiments of the present invention allow for closing the identities gap between a wholesale partner network identity and an IMS network identity by providing a user identities scheme mapping. By so doing, the operator of the IMS network is able to scale very easily its network.

Furthermore, the embodiments of the present invention allow the IMS network operator and the wholesale partner to offer a more feature-rich end-user experience.

Modifications and other embodiments of the disclosed invention will come to mind to one skilled in the art having the benefit of the teachings presented in the foregoing description and the associated drawings. Therefore, it is to be understood that the invention is not to be limited to the specific embodiments disclosed and that modifications and other embodiments are intended to be included within the scope of this disclosure.

What is claimed is:

1. A method for mapping a wholesale network user's identity onto a mobile network user identity that is routable in the mobile network, the method comprising, in a network node:
receiving, through a communication interface of the network node, a request from the user of the wholesale network for a service provided by the mobile network, wherein the user of the wholesale network is not registered in the mobile network;
based on the requested service, selecting, by a processor of the network node, a routable identity among a group of identities associated with the requested service, in the mobile network; and
mapping the selected routable identity of the mobile network to the wholesale network user's identity, by the processor of the network node.

2. A method as defined in claim 1, wherein the mobile network comprises an IMS network.

3. A method as defined in claim 2, wherein the group of identities associated with the requested service is defined by W-IMPU.

4. A method as defined in claim 3, wherein the W-IMPU is associated with a service profile, wherein the service profile is a combination of services offered to the user of the wholesale network user by the mobile network.

5. A method as defined in claim 2, wherein the routable identity comprises a specific IMPU.

6. A method as defined in claim 1, wherein mapping the selected routable identity comprises creating an association between the wholesale network user's identity and the routable identity in a database of the mobile network.

7. A method as defined in claim 6, wherein the mapping of the selected routable identity in the mobile network is valid only for the duration of the association.

8. A network node for mapping a wholesale network user's identity into a mobile network user identity that is routable in the mobile network, the network node comprising:
a communication interface for receiving a request from the user of the wholesale network for a service provided by the mobile network, wherein the user of the wholesale network user is not registered in the mobile network;
a processor operationally connected to the communication interface; and
an instruction repository operationally connected to the processor and storing instructions that when executed by the processor cause the processor to:
based on the requested service, select a routable identity among a group of identities associated with the requested service, in the mobile network; and
map the selected routable identity of the mobile network to the wholesale network user's identity.

9. A network node as defined in claim 8, wherein the mobile network comprises an IMS network.

10. A network node as defined in claim 9, wherein the group of identities associated with the requested service is defined by W-IMPU.

11. A network node as defined in claim 10, wherein the W-IMPU is associated with a service profile, wherein the service profile is a set of services offered to the user of the wholesale network user by the IMS network.

12. A network node as defined in claim 9, wherein the routable identity comprises a specific IMPU.

13. A network node as defined in claim 8, wherein the instructions of the instruction repository further cause the processor to create an association between the wholesale network user's identity and the routable identity in a database of the mobile network.

14. A method for using a wholesale network user's identity to access services provided by a mobile network, the method comprising, in a network node:
receiving, through a communication interface of the network node, a request for a service from the wholesale network user who is not a subscriber of the mobile network;
looking up in a database a routable identity in the mobile network mapped to the wholesale network user's identity, by a processor of the network node;
replacing an identifier of the received request of service with the located routable identity, by the processor of the network node; and
sending, through the communication interface, the request using the routable identity through the mobile network for accessing the requested service in the mobile network;
wherein the routable identity is mapped to the wholesale network user based on the requested service.

15. A method as defined in claim 14, further comprising looking up a service profile that is associated with the requested service.

16. A method as defined in claim 15, wherein the mobile network comprises an IMS network. 17 A method as defined in claim 16, wherein the service profile is associated with W-IMPUs.

18. A method as defined in claim 16, wherein the routable identity comprises a specific IMPU.

19. A network node for using a wholesale network user's identity to access services provided by a mobile network, the network node comprising:
a communication interface for receiving a request for a service from the wholesale network user who is not a subscriber of the mobile network;
a processor operationally connected to the communication interface; and
an instruction repository operationally connected to the processor and storing instructions that when executed by the processor cause the processor to:
locate a routable identity mapped to the wholesale network user's identity in a database of the mobile network; and
replace an identifier of the received request of service with the located routable identity;
wherein the communication interface further sends the request using the routable identity through the mobile network for accessing the requested service in the mobile network; and wherein the routable identity is mapped to the wholesale network user identity based on the requested service.

20. A network node as defined in claim 19, wherein the processor further locates a service profile that is associated with the requested service.

21. A network node as defined in claim 20, wherein the mobile network comprises an IMS network.

22. A network node as defined in claim 21, wherein the service profile is associated with W-IMPUs.

23. A network node as defined in claim 21, wherein the routable identity comprises a specific IMPU.
